(19) United States
(12) Patent Application Publication
(10) Pub. No.: US 2013/0180999 A1
(43) Pub. Date: Jul. 18, 2013

(54) PRE-FILLED FLUID CARTRIDGE AND FILLING METHODS

(71) Applicants: C. Garyen Denning, Lexington, KY (US); Theodore J. Mosler, Raleigh, NC (US)

(72) Inventors: C. Garyen Denning, Lexington, KY (US); Theodore J. Mosler, Raleigh, NC (US)

(21) Appl. No.: 13/741,159

(22) Filed: Jan. 14, 2013

Related U.S. Application Data
(60) Provisional application No. 61/586,395, filed on Jan. 13, 2012.
(60) Provisional application No. 61/587,383, filed on Jan. 17, 2012.

(51) Int. Cl. A61J 1/14; B65B 3/00; B65D 8/00

(52) U.S. Cl. CPC A61J 1/14; B65D 15/02; B65B 3/003; B65B 3/006
USPC 220/625; 206/438; 53/452; 53/426; 53/433

(57) ABSTRACT

Disclosed are cartridge filling systems and methods that can include providing a vial body defining a vial lumen, providing a floating stopper positioned within the vial lumen, providing an end cap, where the proximal end of the end cap can abut the distal end of the floating stopper such that the floating stopper is prevented from moving distally within the vial lumen, filling at least a portion of the vial lumen with a fluid, and removing the end cap from the vial body after filling at least a portion of the vial lumen with a fluid.

### REFERENCE TO RELATED APPLICATIONS

The present application claims priority of U.S. provisional application Ser. No. 61/586,395, filed Jan. 13, 2012, and U.S. provisional application Ser. No. 61/587,383, filed Jan. 17, 2012, and hereby incorporates the same applications herein by reference in their entirety.

### TECHNICAL FIELD

This application relates generally to pre-filled cartridges and filling methods for medical devices, and more particularly to methods for filling a pre-filled fluid cartridge provided in a tub or nest.

### BACKGROUND

In conventional filling methods, commercial glass cartridges generally go through a wash station in bulk while standing in an upright position. Following a wash, silicone is typically applied to the internal surface of the glass. Parts of the cartridge are generally then dried, steam sterilized and depyrogenated by heating at elevated temperatures. In parallel activities, floating plungers are often bulk washed, siliconized, sterilized, and depyrogenated.

Glass cartridges generally enter the filling line in an upright position and a floating plunger is placed into the larger of the two open ends. The plungers are generally set to the desired position within the cartridge depending on the volume of medication to be filled. Fluid is generally aseptically dispensed into the cartridges from the top, flanged end. Cartridges generally then pass beneath a sealing station and a rubber lined aluminum cap is loosely placed over the upper, flanged end of the cartridge. A crimping station generally presses the lined seal down into place while crimping the lower edge of the aluminum seal around the flanged neck of the cartridge. Parts are then labeled and bulk packaged.

### SUMMARY

In accordance with one embodiment, a cartridge can include a vial body that can define a vial lumen, where the vial body can have a proximal end and a distal end. The cartridge can include a flange positioned at about the proximal end of the vial body, a floating stopper that can be positioned within the vial lumen defined by the vial body, where the floating stopper can have a proximal end and a distal end, and an end cap. The end cap can have a proximal end and a distal end, where the proximal end of the end cap can abut the distal end of the floating stopper such that the floating stopper can be retained at a first position within the vial lumen.

In accordance with one embodiment, a method of filling a cartridge can include providing a vial body defining a vial lumen, where the vial body can have a proximal end and a distal end, providing a floating stopper that can be positioned within the vial lumen defined by the vial body, where the floating stopper can have a proximal end and a distal end, and providing an end cap. The end cap can have a proximal end and a distal end, where the proximal end of the end cap can abut the distal end of the floating stopper such that the floating stopper can be prevented from moving distally within the vial lumen. The method can include filling at least a portion of the vial lumen with a fluid and removing the end cap from the vial body after filling at least a portion of the vial lumen with the fluid.

### BRIEF DESCRIPTION OF THE DRAWINGS

It is believed that certain embodiments will be better understood from the following description taken in conjunction with the accompanying drawings in which:

FIG. 1 is a side cross-sectional view depicting a vial body in accordance with one embodiment;

FIG. 2 is a side cross-sectional view depicting a cartridge in accordance with one embodiment, where the cartridge can include the vial body shown in FIG. 1, a floating stopper, and an end cap;

FIG. 3 is a right side cross-sectional view of a tub according to one embodiment, where the tub is shown with a rack and a plurality of the cartridges shown in FIG. 2;

FIG. 4 is a right side cross-sectional view depicting the tub of FIG. 3, where the tub is shown sealed with a lid;

FIG. 5 is a right side cross-sectional view depicting the tub of FIG. 4, where the tub is shown positioned within a pouch;

FIG. 6 is a right side cross-sectional view depicting the tub of FIG. 5, where the tub is shown during a sterilization step according to one embodiment;

FIG. 7 is a right side cross-sectional view depicting the tub of FIG. 4, where the lid is shown being removed from the tub;

FIG. 8 is a side cross-sectional view depicting the cartridge of FIG. 2, where the cartridge is shown prior to being filled with a fluid;

FIG. 9 is a side cross-sectional view depicting the cartridge of FIG. 2, where the cartridge is shown after being filled at least partially with a fluid;

FIG. 10 is a side cross-sectional view depicting the cartridge of FIG. 2, where the cartridge is shown prior to the insertion of a fixed stopper;

FIG. 11 is a side cross-sectional view depicting the cartridge of FIG. 2, where the cartridge is shown after the insertion of the fixed stopper shown in FIG. 10;

FIG. 12 is a side cross-sectional view depicting the cartridge of FIG. 11, where the cartridge is shown positioned in a tooling nest;

FIG. 13 is a side cross-sectional view depicting the cartridge of FIG. 12, where the cartridge is shown prior to insertion of a button;

FIG. 14 is a side cross-sectional view depicting the cartridge of FIG. 12, where the cartridge is shown after insertion of the button shown in FIG. 13;

FIG. 15 is a side cross-sectional view depicting a pre-filled cartridge according to one embodiment;

FIG. 16 is a side cross-sectional view depicting the cartridge of FIG. 11, where the cartridge is shown prior to the insertion of a button according to an alternate embodiment;

FIG. 17 is a side cross-sectional view depicting the cartridge of FIG. 16, where the cartridge is shown after insertion of the button;

FIG. 18 is a side cross-sectional view depicting the cartridge of FIG. 17, where the cartridge is shown prior to being coupled with a collar;

FIG. 19 is a side cross-sectional view depicting a pre-filled cartridge of FIG. 18 where the cartridge is shown coupled to the collar;

FIG. 20 is a side view of the pre-filled cartridge of FIG. 15, where the pre-filled cartridge is shown prior to the placement of a tamper evident label;

FIG. 21 is a side view of the pre-filled cartridge of FIG. 15, where the pre-filled cartridge is shown after the placement of the tamper evident label;

FIG. 22 is a side cross-sectional view of a vial according to an alternate embodiment;

FIG. 23 is a side cross-sectional view of a cartridge according to an alternate embodiment, where the cartridge can include the vial shown in FIG. 23, a floating stopper, and an end cap;

FIG. 24 is a right side cross-sectional view depicting a tub according to an alternate embodiment, where the tub is shown containing a plurality of the cartridges shown in FIG. 23 and positioned within a pouch;

FIG. 25 is a right side cross-sectional view depicting the tub and pouch of FIG. 24, where the tub is shown during a sterilization step according to one embodiment;

FIG. 26 is a side cross-sectional view depicting the tub of FIG. 24, where the lid is shown being removed from the tub;

FIG. 27 is a side cross-sectional view depicting the cartridge of FIG. 23, where the cartridge is shown prior to being filled with a fluid;

FIG. 28 is a side cross-sectional view depicting the cartridge of FIG. 23, where the cartridge is shown after being filled with the fluid;

FIG. 29 is a side cross-sectional view depicting the cartridge of FIG. 23, where the cartridge is shown prior to the insertion of a fixed stopper;

FIG. 30 is a side cross-sectional view depicting the cartridge of FIG. 23, where the cartridge is shown after the insertion of the fixed stopper shown in FIG. 29;

FIG. 31 is a side cross-sectional view depicting the cartridge of FIG. 29, where the cartridge is shown prior to the placement of a button;

FIG. 32 is a side cross-sectional view depicting a pre-filled cartridge of FIG. 29 where the cartridge is shown after placement of the button;

FIG. 33 is a side view of the pre-filled cartridge according to FIG. 32, where the pre-filled cartridge is shown prior to the placement of a tamper evident label;

FIG. 34 is a side view of the pre-filled cartridge according to FIG. 32, where the pre-filled cartridge is shown after the placement of the tamper evident label;

FIG. 35 is a side cross-sectional view of a pre-filled cartridge according to an alternate embodiment;

FIG. 36 is a side cross-sectional view of a pre-filled cartridge according to an alternate embodiment;

FIG. 37 is a side cross-sectional view of a cartridge according to an alternate embodiment;

FIG. 38 is a side cross-sectional view of the cartridge according to FIG. 37, where the cartridge is shown prior to delivery of a fluid;

FIG. 39 is a side cross-sectional view of the cartridge according to FIG. 37, where the cartridge is shown after delivery of the fluid;

FIG. 40 is a side cross-sectional view of the cartridge according to FIG. 39, where the cartridge is shown with an associated vacuum tool;

FIG. 41 is a side cross-sectional view of the cartridge according to FIG. 39, where the cartridge is shown prior to seating a fixed stopper in the cartridge;

FIG. 42 is a side cross-sectional view of the cartridge according to FIG. 39, where the cartridge is shown after a vacuum is released and the fixed stopper has been seated in the cartridge;

FIG. 43 is a side cross-sectional view of a pre-filled cartridge according to an alternate embodiment;

FIG. 44 is a side view of a pre-filled cartridge according to one embodiment;

FIG. 45 is a side cross-sectional view of the pre-filled cartridge according to FIG. 44, where the pre-filled cartridge is shown prior to an end cap being removed; and

FIG. 46 is a side cross-sectional view of the pre-filled cartridge according to FIG. 44, where the pre-filled cartridge is shown with the end cap removed.

### DETAILED DESCRIPTION

Disclosed are systems and methods that can be used for filling pre-filled syringes aseptically. Embodiments described herein can include positioning the partial assembly of a pre-filled cartridge into a tub and nest that is triple sealed with, for example, a synthetic, flashspun high-density polyethylene fibers, and then sterilized. In accordance with embodiments described herein, floating stoppers can be bulk packaged and sterilized. Components can be supplied to a pre-filled syringe fill line where the synthetic overwrap can be removed, the syringes filled, and a fixed stopper inserted.

Embodiments described herein can use equipment traditionally used for pre-filled syringe filling to produce an alternate type of drug cartridge. In one version, the floating stoppers can be pre-assembled as part of the tub and nest subassembly, not during the aseptic fill operation. The filling operation can include placing a fixed stopper to close the cartridge. Embodiments described herein can provide an alternative primary storage container and fill method for injectable medications that can leverage the existing infrastructure established for the pre-filled syringe market.

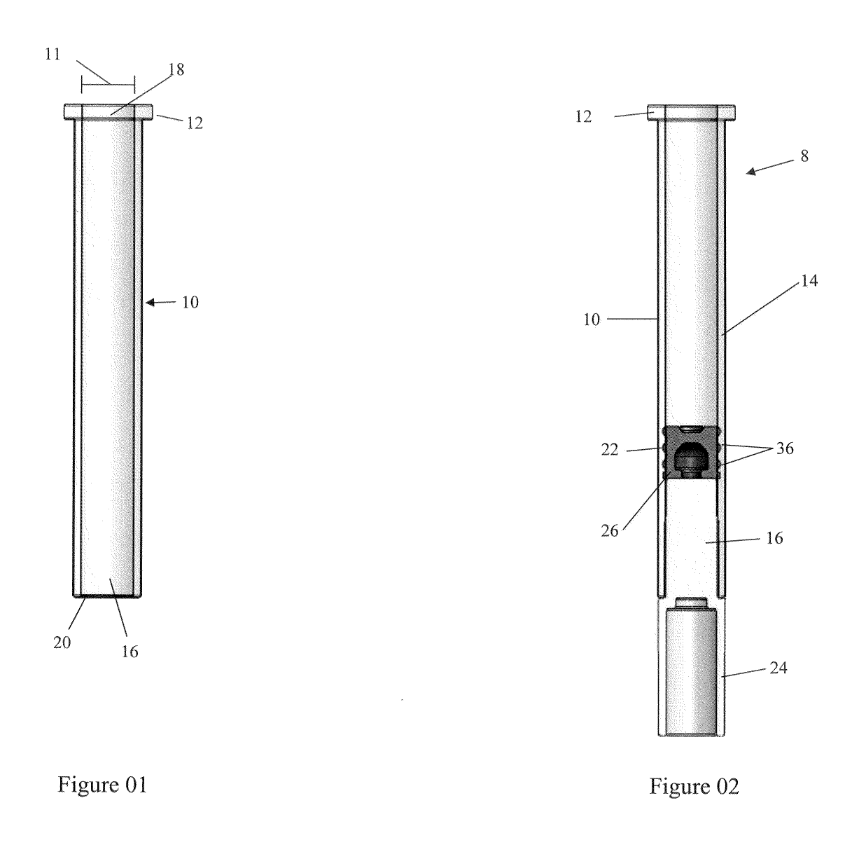

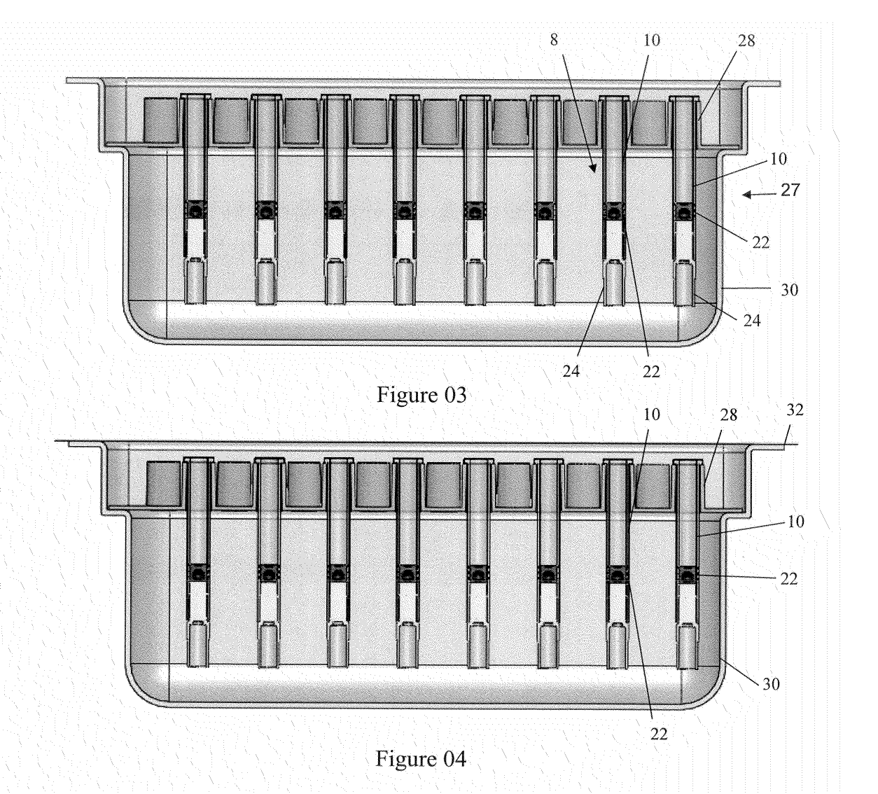

With reference to FIG. 1, one version of a filling process or method can begin with the washing, lubrication, or depyrogenation of a vial 10 or housing. The vial 10 can be configured from glass, plastic, or any suitable material. The vial 10 depicted in FIG. 1 can include a first opening 18 at a proximal end of the vial body 14 and a second opening 20 at the distal end of the vial body 14. The vial body 14 can define a vial lumen 16. The vial 10 can have a uniform inner diameter 11 and can include a flange 12 at one end. It will be appreciated that vial 10 can have any suitable inner diameter including non-uniform inner diameters. The flange 12 of the vial 10 can facilitate hanging the vial 10 in a tub nest system 27 (FIG. 3) or aseptic filling equipment where, in one version, the vial 10 can be configured such that it can be compatible with existing pre-filled syringe manufacturing or filling equipment.

As depicted in FIG. 2, a floating stopper 22 can be placed within the vial lumen 16 defined by the vial body 14 and a distal end cap 24 can be inserted into the vial lumen 16. The distal end cap 24 can help maintain sterility of the distal end 26 of the floating stopper 22 until the vial 10 is used and can be pre-assembled prior to filling. A cartridge 8 can include, for example, the vial 10, the floating stopper 22, and the distal end cap 24.

As shown in FIG. 3, a plurality of vials 10, floating stoppers 22, and distal end caps 24 associated with a plurality of cartridges 8 can be placed within a rack 28 that can sit within a tub 30 to form a tub nest system 27. The tub 30 can be configured from any suitable material such as, for example, plastic. The cartridges 8 can be assembled prior to filling, where the cartridges 8 can be shipped in the illustrated configuration to a filling site.

As shown in FIG. 4, the tub 30 can be sealed with a lid 32, where the lid 32 can be formed, for example, from flashspun high-density polyethylene fibers or any other suitable material. The lid 32 can provide a primary barrier to microbial contamination, and as such, can be formed from a material that provides such protection.

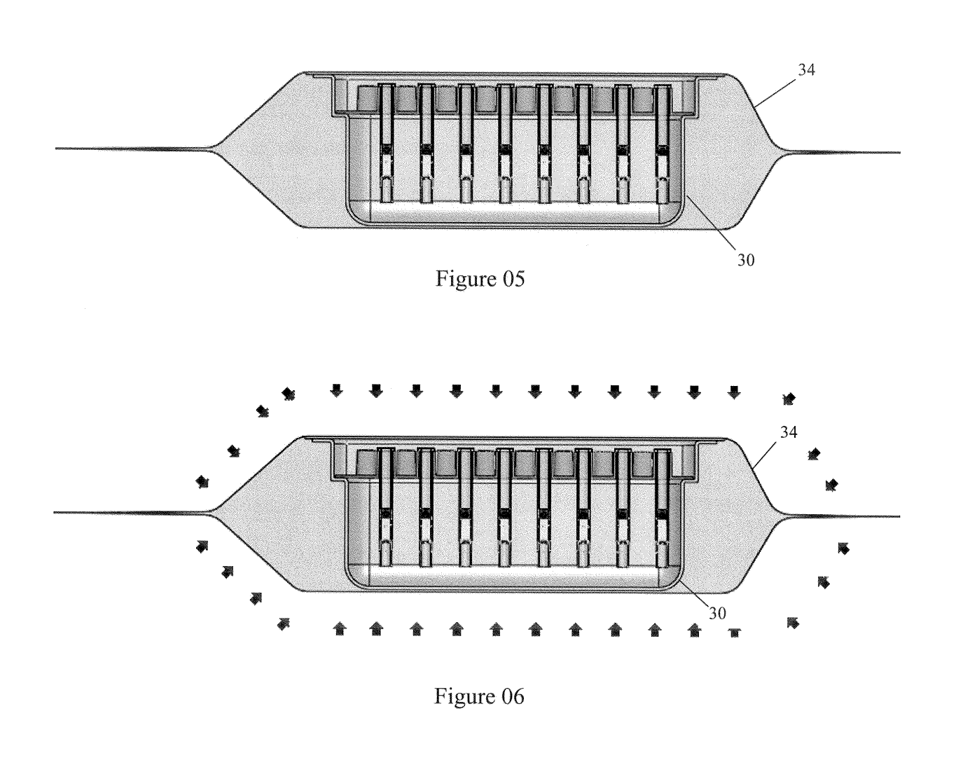

As shown in FIG. 5, a pouch 34 of, for example, flashspun high-density polyethylene fibers, can be placed over the tub 30 or encapsulate the tub 30 such that the pouch 34 can provide a second microbial barrier to avoid contamination. In one version, one or a plurality of pouches 34 can encapsulate the tub 30, where each of the plurality of pouches 34 encapsulating the tub 30 can be removed in succession during the filling process as the tub 30 moves through increasing levels of particulate containment such that the vial 10 can be filled aseptically.

With reference to FIG. 6, the tub 30 can be subject to sterilization by, for example, ethylene oxide EtO gas, such that all fluid contacting surfaces can be made sterile. It will be appreciated that any suitable sterilization method, such as gamma irradiation, e-beam, steam sterilization, or combinations thereof, can be used in accordance with methods described herein. In one example, the floating stopper 22 can be semi-permeable to gas such that, for example, EtO gas can sterilize the areas in between the seal ribs 36 (FIG. 2) of the floating stopper 22. The floating stopper 22 can be configured from any suitable material such as, for example, isoprene, butyl rubber, or combinations thereof. The floating stopper 22 can be configured from, for example, one or a plurality of materials that can permit both sterilization of the area between the seal ribs 36 as well as provide adequate drug stability for long term storage.

In one version, a sterilized tub 30 can be transported to a facility that performs syringe filling with equipment designed to work with a ready-to-fill (RTF) tub configuration.

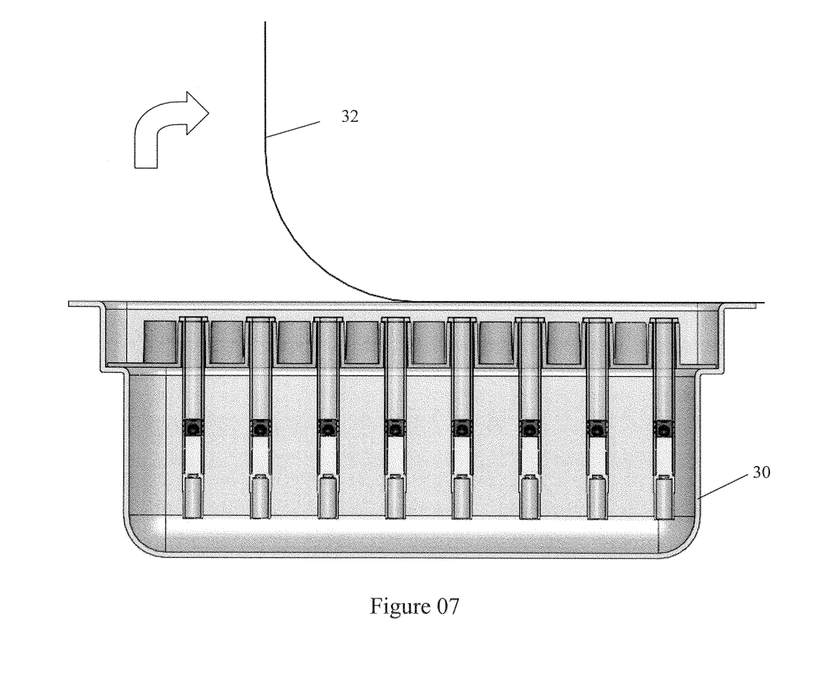

The pouch 34 can be removed and the tub 30 can be fed into an automated RTF fill machine (not shown). As shown in FIG. 7, the lid 32 can be peeled away or otherwise removed from the tub 30 to permit filling and stoppering.

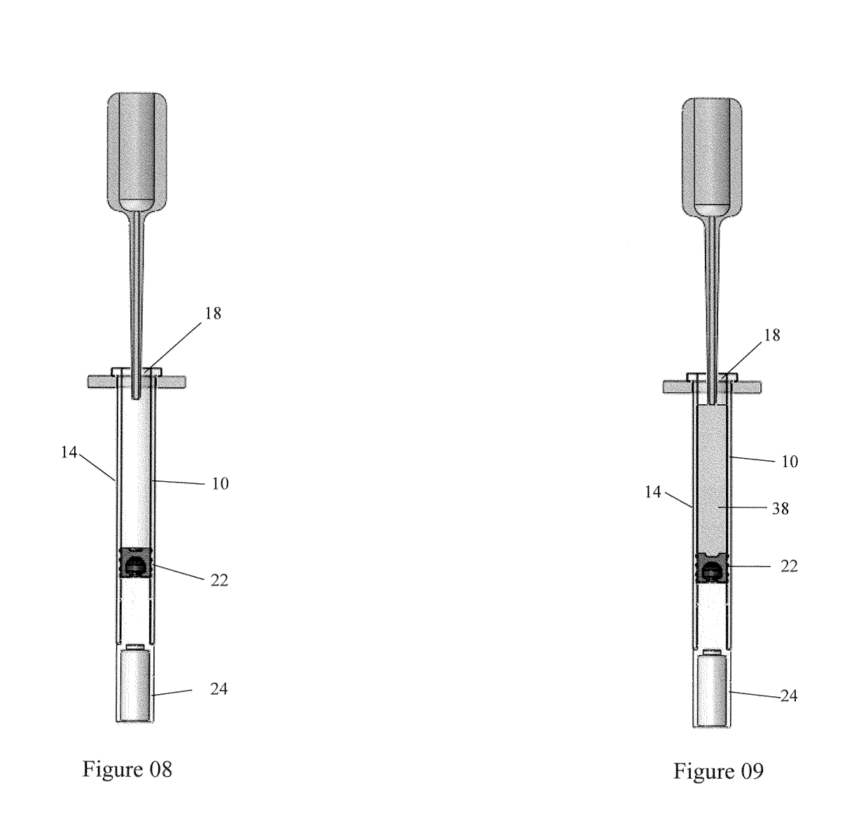

In one version, the vial 10 can be filled aseptically from the first opening 18 of the vial 10. FIGS. 8 and 9 depict a filling step where substantially all or a portion of the vial 10 can be filled with a fluid 38 such that minimal or no air may present within the vial lumen 16 defined by the vial body 14. The fluid 38 can be a medicament or any other suitable fluid.

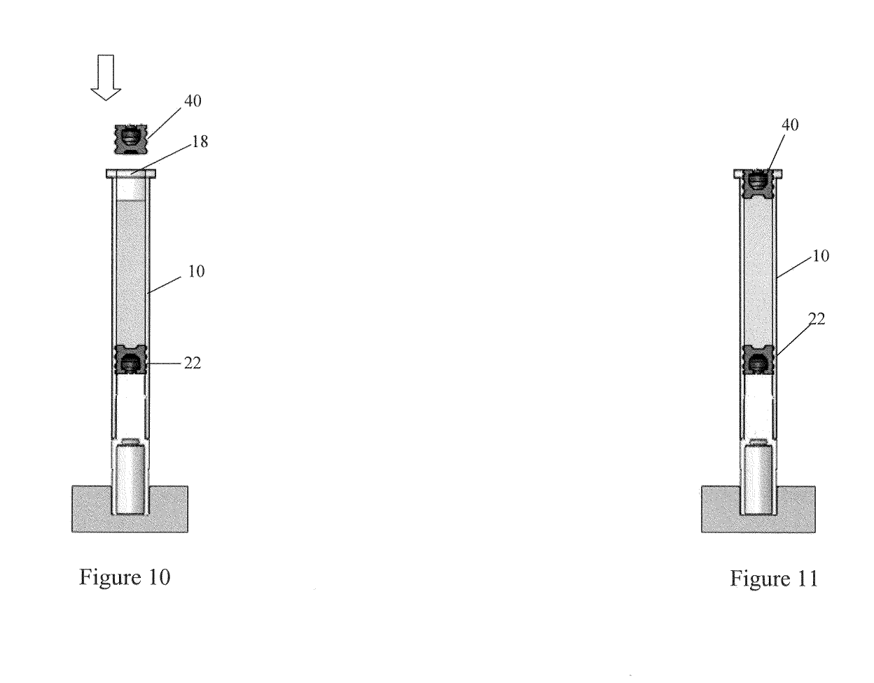

Referring to FIGS. 10 and 11, a fixed stopper 40 can be placed into the first opening 18 of the vial 10 as shown in FIGS. 10 and 11. The one or a plurality of fixed stoppers 40 can have previously been sterilized in bulk. In one version, a vent tube (not shown) can be placed between the inner diameter 11 of the vial 10 and the outer diameter of the fixed stopper 40 and can permit seating the fixed stopper 40 into the vial 10 without trapping excess air distal to the fixed stopper 40.

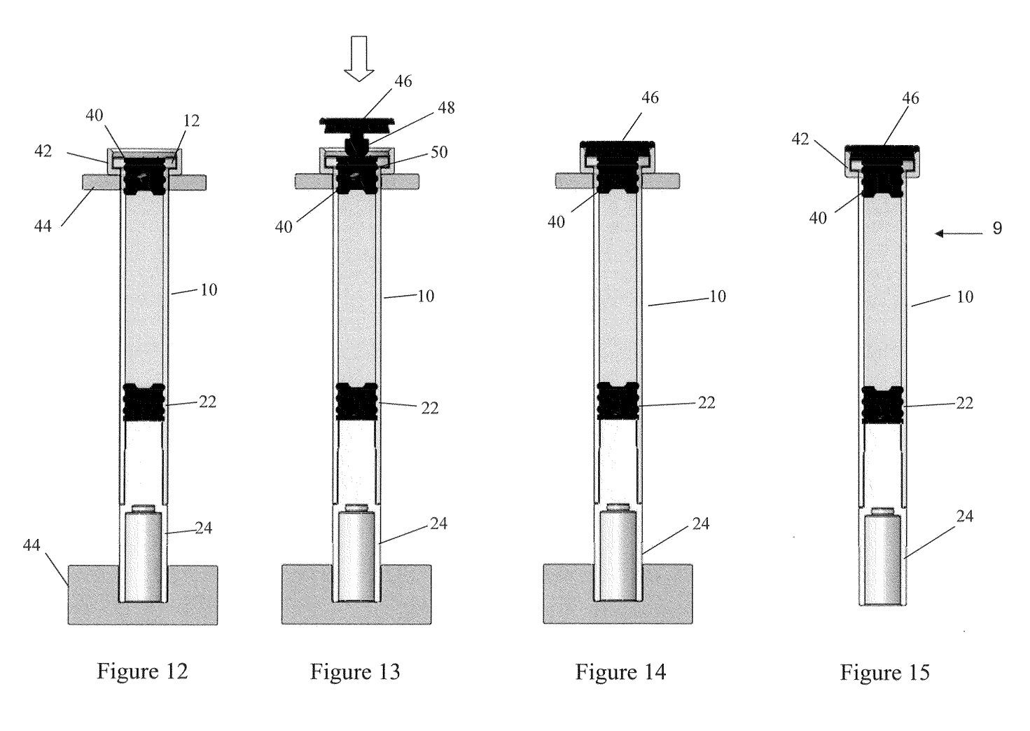

Referring to FIG. 12, filled vials 10 can leave the aseptic fill area in nests 44 and tubs (not shown) for further processing. A collar 42 can be placed beneath the flange 12 and the vial 10 can be placed in the nest 44 to support the distal end of the collar 42 and the distal end of the distal cap 24 as depicted in FIG. 12. It will be appreciated that the tooling nest 44 can, alternatively, support the collar 42 or distal cap 24 alone.

A button 46 can be coupled with the proximal end of the vial 10, where a barb 48 on the button 46 can seat within a cavity 50 defined by the fixed stopper 40 as depicted in FIGS. 13 and 14. The distal cap 24 can be supported by the nest 44 to prevent the floating stopper 22, fluid 38, and the fixed stopper 40 from moving distally while pressing the button 46 into the fixed stopper 40. In one version, a tamper evident label (not shown) and press fit between the distal cap 24 and vial inner diameter 11 can provide sufficient resistance to distal movement of the floating stopper 22 such that the button 46 can be coupled to the fixed stopper 40 without the need for placement of the tooling nest 44 at the distal end of the distal cap 24. In one version, the vial 10 can contain minimal or no compressible gasses such there can be sufficient hydraulic force within the vial lumen 16 to facilitate coupling the fixed stopper 40 with the button 46. The collar 42 can prevent the button 46 and fixed stopper 40 from moving proximally when the vial 10 is being used. The barb 48 on the button 46 can prevent the fixed stopper 40 from moving distally during use of the vial 10 when, for example, users apply a vacuum within the vial lumen 16 during aspiration.

FIG. 15 depicts one version of a pre-filled cartridge 9 including vial 10, floating stopper 22, fixed stopper 40, button 46, collar 42, and a fluid 38 that can be ready for labeling and further post production processes. It will be appreciated that the cartridge 8 and pre-filled cartridge 9 can have any suitable number and configuration of components.

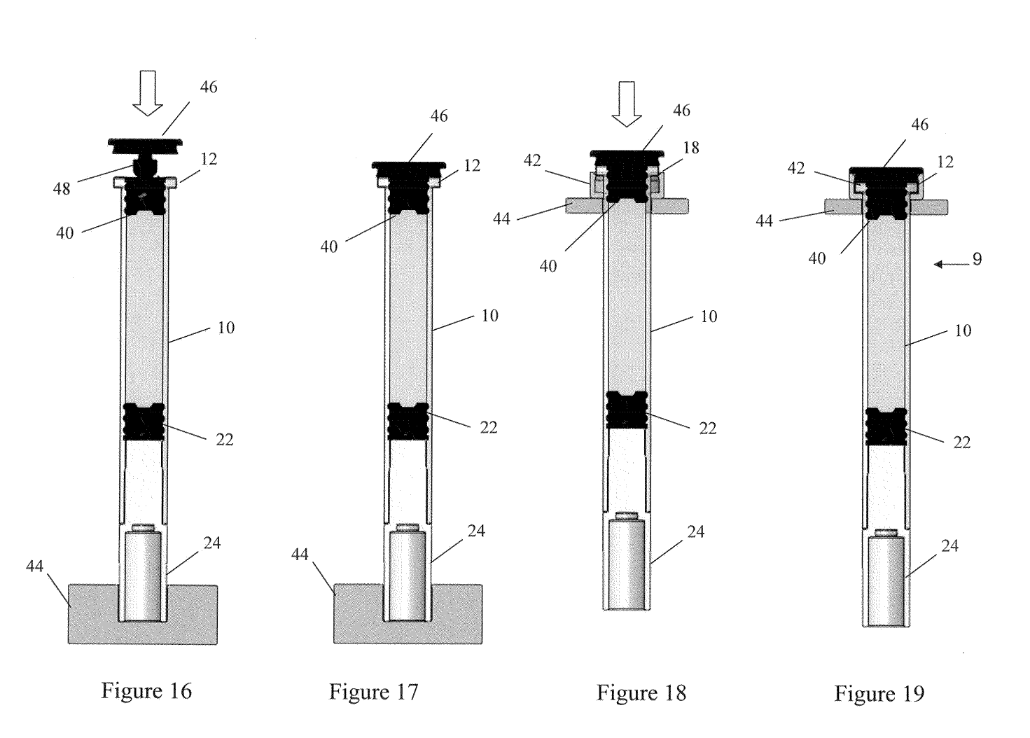

As shown in FIGS. 16-19, the vial 10, collar 42, and button 46 can be assembled in any suitable order. For example, the button 46 can be engaged with the fixed stopper 40 while the only the distal cap 24 is supported with the nest 44, or with any other tooling fixture. The collar 42 can then be coupled with the vial 10 as shown in FIGS. 18 and 19. In one version, performing the step of coupling the button 46 with the fixed stopper 40 separately from the step of coupling the button 46 with the collar 42 may help better manage tolerance issues.

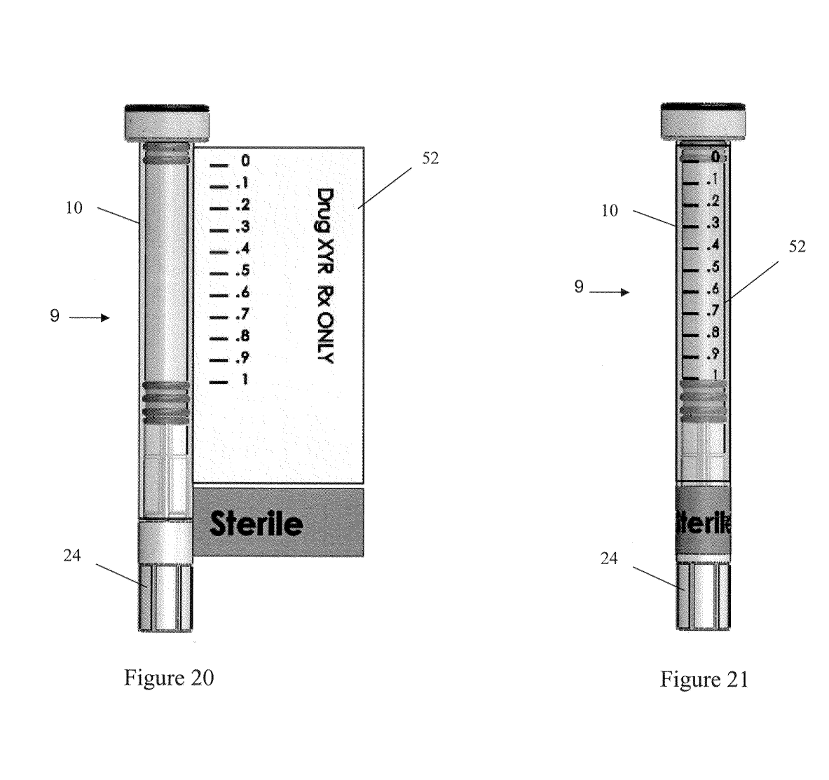

In one version, with reference to FIGS. 20 and 21, a tamper evident label 52 can be applied over the interface between the distal cap 24 and the vial 10 to facilitate bulk packaging of the pre-filled cartridges 9 without the need for packaging pouches. A second label (not shown) can be applied to the outer surface of the vial 10 to indicate drug specific information, graduation marks for measuring fluid delivery, or any other suitable information.

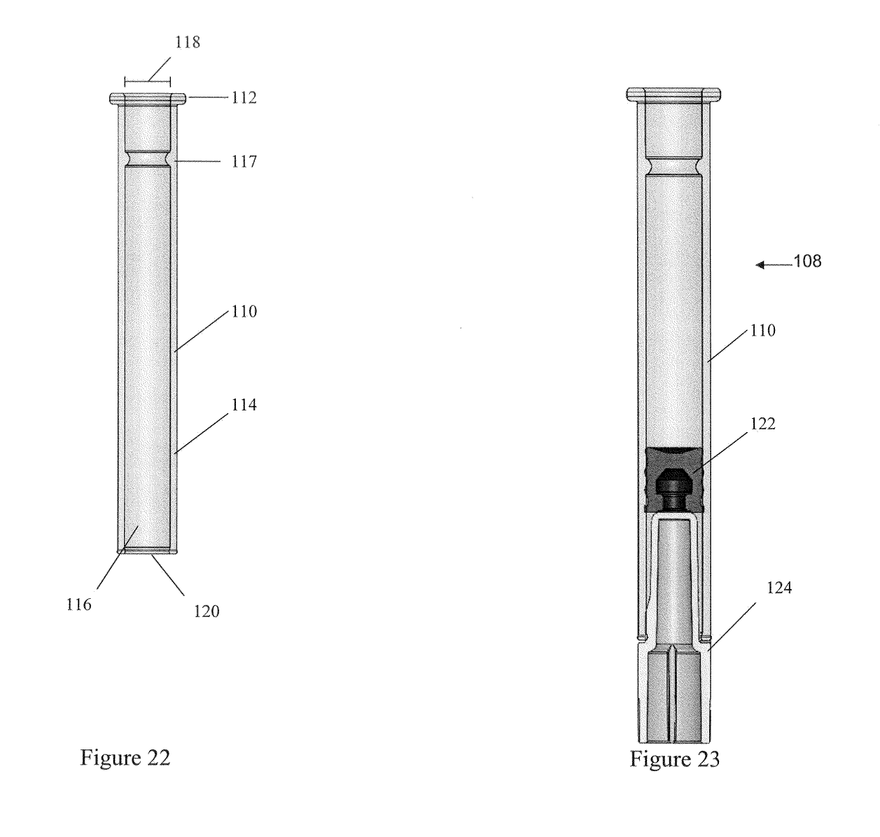

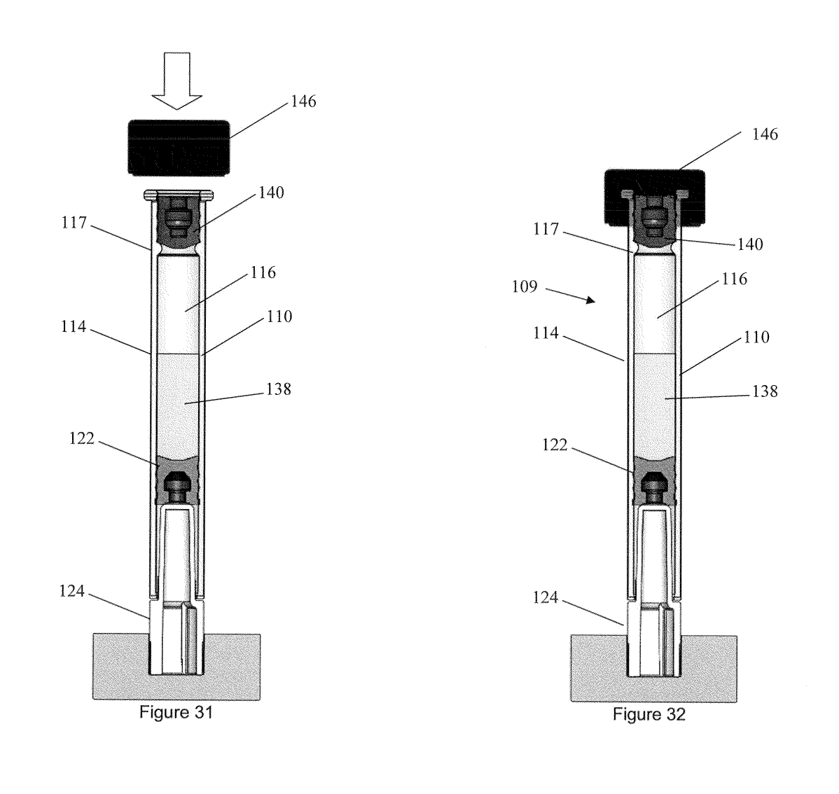

FIGS. 22-34 depict an alternate embodiment of a vial 110 that can be used when partial filling of vials with compressible gasses is desired. FIGS. 22-25 depict a portion of a method that can occur prior to filling, FIGS. 26-30 depict one version of a filling process, and FIGS. 31-34 depict one version of manufacturing steps that can occur subsequent to the filling process.

The vial 110 depicted in FIG. 22 can include a first opening 118 at a proximal end and a second opening 120 at a distal end of a vial body 114. The vial body 114 can define a vial lumen 116. The vial 110 can include a flange 112 at one end. The vial 110 can include a region 117, such as a rib or inwardly projecting vial portion, having an inner diameter narrower than the inner diameter at the proximal or distal ends of the vial body 114. The region 117 can be positioned near the proximal end of the vial 110 distal of the flange 112. In one version, with reference to FIG. 23, a cartridge 108 can include the vial 110, a floating stopper 122, and a distal end cap 124.

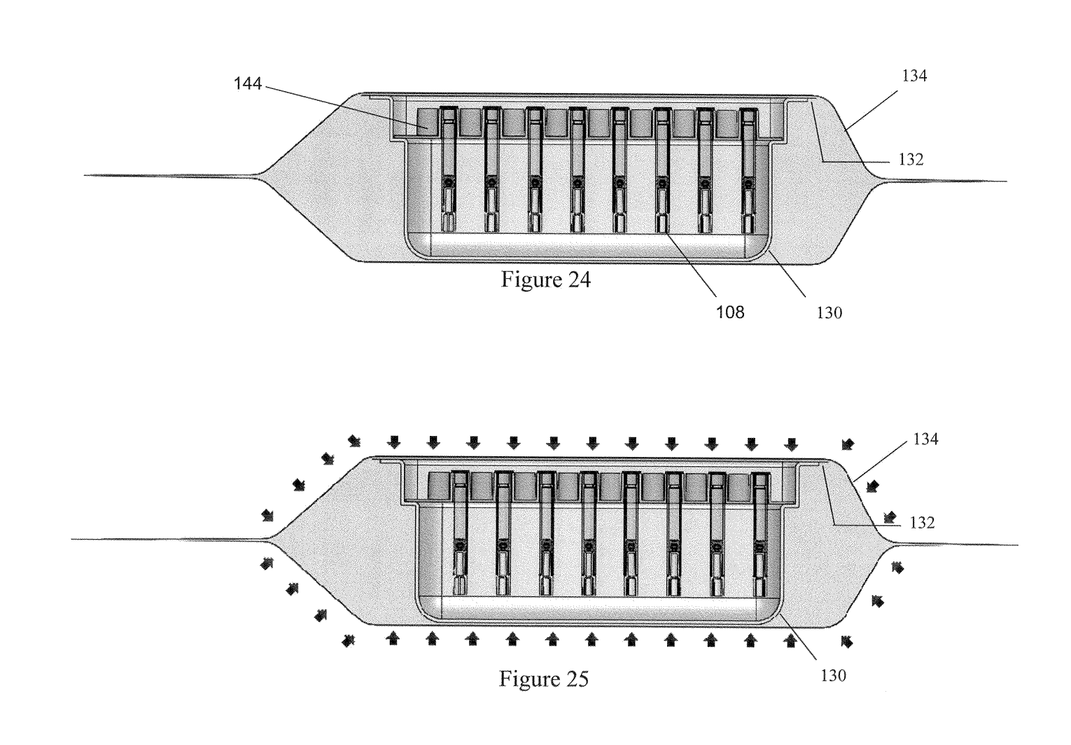

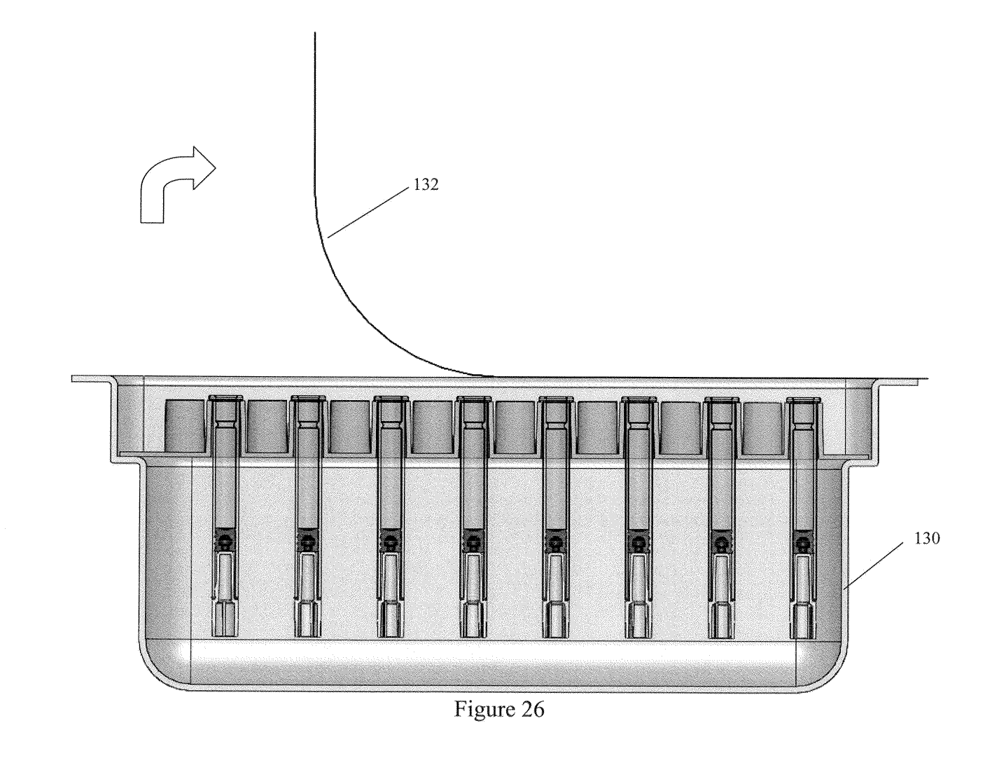

As shown in FIG. 24, a pouch 134 configured, for example, from flashspun high-density polyethylene fibers, can be placed over a tub 130 having a lid 132 such that the pouch 134 may provide an additional microbial barrier to contamination. The tub 130 can be configured to retain one or a plurality of cartridges 108 in a nest 144. In one version, one or a plurality of pouches 134 can encapsulate the tub 130, where each of the plurality of pouches 134 encapsulating the tub 130 can be removed in succession during the filling process as the tub 130 moves through increasing levels of particulate containment such that the one or a plurality of cartridges 108 can be filled aseptically. As shown in FIG. 25, tub 130 and pouch 134 can be subject to sterilization such that all fluid contacting surfaces can be made sterile.

Sterilized tubs 130 and pouches 134 can be transported to a facility that can perform syringe filling with equipment designed to work with a ready-to-fill (RTF) tub configuration. One or a plurality of pouches 134 can be removed from the tub 130 as described herein. As shown in FIG. 26, the lid 132 can be peeled away from the tub 130 by any suitable mechanism prior to the filling process.

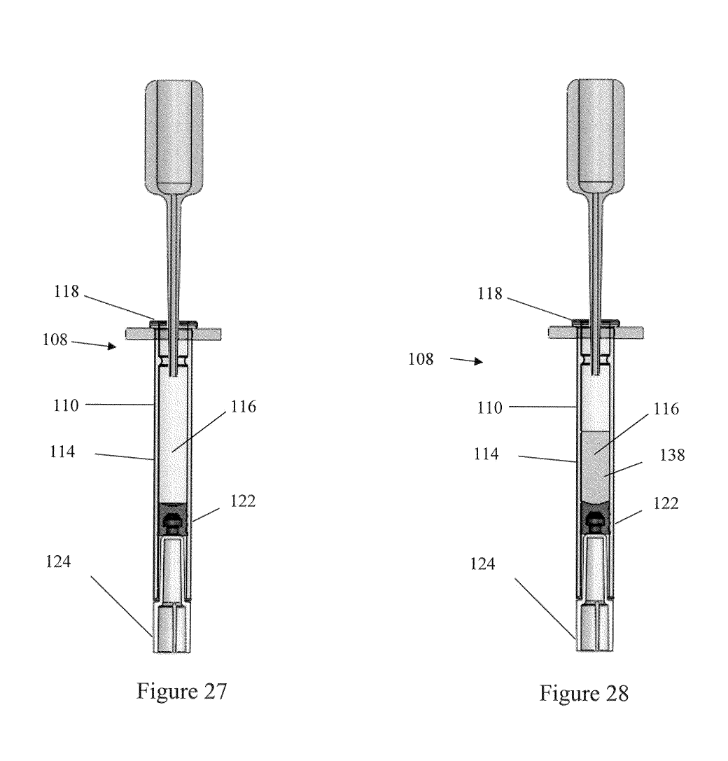

With reference to FIGS. 27 and 28, the cartridge 108 can be filled aseptically through the first opening 118. Shown in FIG. 28 is one version of a filling process where the cartridge 108 can be partially filled with a fluid 138.

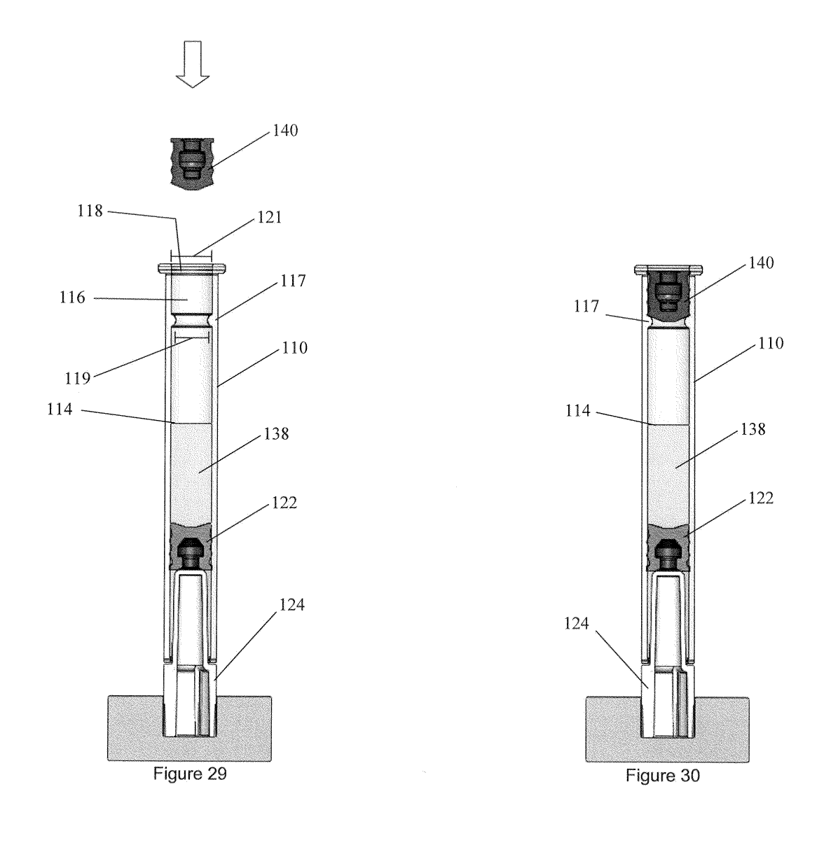

As shown in FIGS. 29 and 30, a fixed stopper 140 can be inserted into the vial lumen 116 defined by the vial 110 and can be seated against the region 117 having an internal diameter 119 narrower than the internal diameter 121 of the first opening 118. A vent tube (not shown) can be inserted between the inner diameter of the vial 110 and the outer diameter of the fixed stopper 140 such that the fixed stopper 140 can be seated into the vial 110 without creating pressure within the vial 110.

The vial 110, once filled, can leave the aseptic fill area in a nest and tub for further processing. As shown in FIGS. 31 and 32, a one piece button 146 can be applied to the proximal end of the vial 110 to retain the fixed stopper 140. The region 117 of the vial 110 can prevent the fixed stopper 140 from moving distally within the vial 110 when the button 146 is coupled with the fixed stopper 140. In use, the region 117 on the vial can prevent the fixed stopper 140 from moving distally when users apply, for example, a vacuum within the vial 110 during aspiration. The button 146 can prohibit the fixed stopper 140 from moving proximally within the assembly when the vial 110 is under pressure during normal use. In an alternate version, a two piece button and collar arrangement (not shown) can be used. FIG. 32 depicts one version of a pre-filled cartridge 109 that that can include the vial 110, floating stopper 122, fixed stopper 140, button 146, end cap 124, and fluid 138.

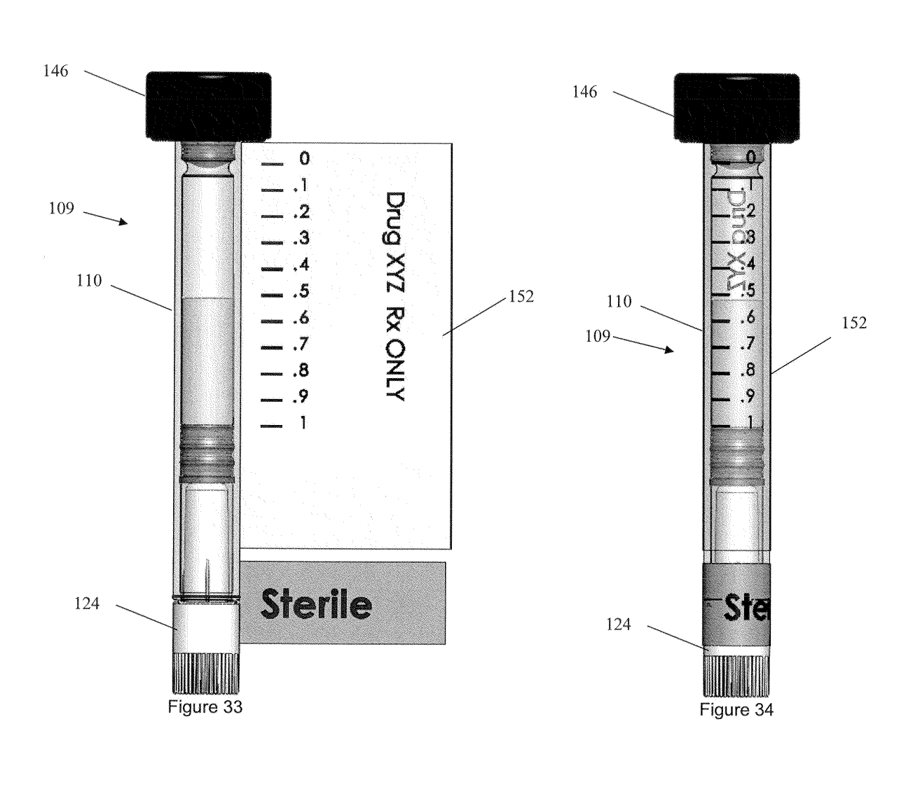

With reference to FIGS. 33 and 34, a tamper evident label 152 can be applied over the interface between the distal end cap 124 and the pre-filled cartridge 109 to facilitate bulk packaging of the pre-filled cartridges 109 without the need for packaging pouches. A second label (not shown) can also be applied to the outer surface of the pre-filled cartridges 109 to indicate drug specific information, and/or graduation marks for measuring fluid delivery, or any other suitable information.

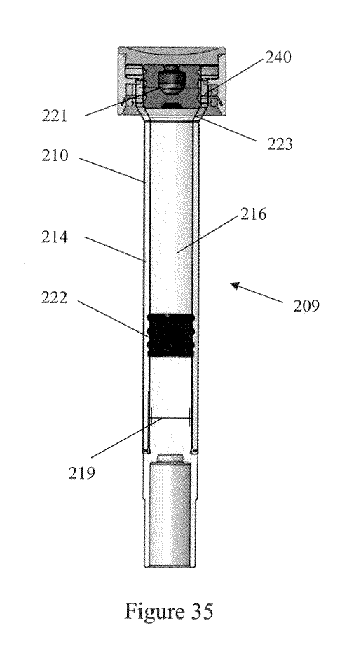

FIG. 35 illustrates an alternate version of a vial 210 of a pre-filled cartridge 209 that can permit partially filling a fluid cartridge with compressible gasses. The vial 210 can include a vial body 214 defining a vial lumen 216 into which a floating stopper 222 can be inserted. As shown, the inside diameter 221 of the proximal end of the vial body 214 can be wider than the inner diameter 219 at the distal end of the vial 210. The outer diameter of a fixed stopper 240 can be sufficiently wide to seal with the inside diameter 221 of the proximal end of the vial 210. The fixed stopper 240 can be prevented from moving distally within the vial 210 by the transition region 223 between the inner diameter 221 of the proximal end of the vial 210 and the inner diameter 219 of the distal end of the vial 210. The method of vial 210 filling and assembly can, for example, generally follow the steps described herein with respect to other versions. The vial 210 may allow for the use of readily available fixed stoppers 240 of a standard size, where accommodating standard fixed stoppers 240 may improve compatibility with existing equipment used to feed fixed stoppers 240 into the filling line.

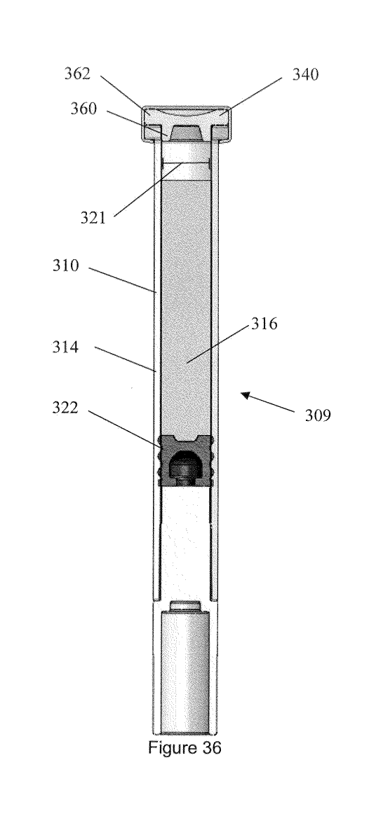

FIG. 36 illustrates an alternate version of a vial 310 for a pre-filled cartridge 309 that can permit partially filling a fluid cartridge with compressible gasses. The vial 310 can include a vial body 314 defining a vial lumen 316 into which a floating stopper 322 can be inserted. As shown, the inside diameter 321 of the vial body 314 can be substantially uniform. A fixed stopper 340 can include a distal portion 360 that can seal with the inside diameter 321 of the vial body 314 and a flange 362 that can be wider than the inside diameter 321 of the vial body 314 such that the flange 362 can prevent the fixed stopper 340 from moving distally during normal use, for example, when users apply a vacuum within the vial lumen 316 during aspiration.

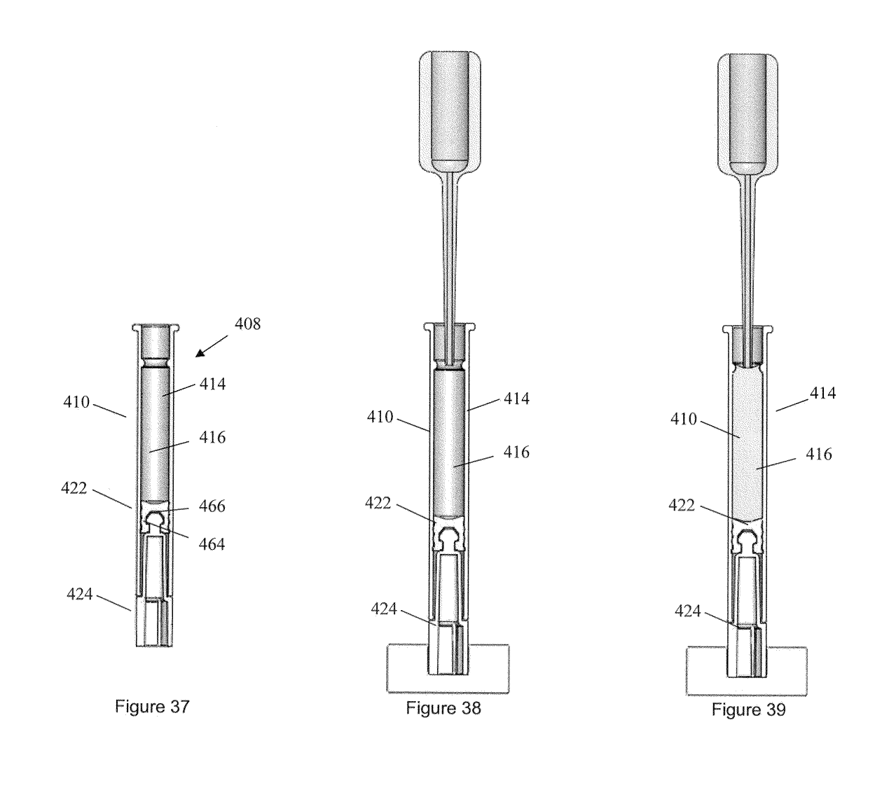

FIG. 37 illustrates an alternate version of a vial 410 of a cartridge 408 that can be compatible with vacuum filling methods. The vial 410 can include a vial body 414 defining a vial lumen 416 into which a floating stopper 422 can be inserted. A distal cap 424 can include a post 464 or barb configured to engage a cavity 466 defined by the floating stopper 422 such that the floating stopper can be detachably coupled with the distal cap 424. Assembly, sterilization, and filling of the vial 410, distal cap 424, and floating stopper 422 can be performed in accordance with methods described herein. FIGS. 38-43 depict one version of a method for filling the vial 410 such that minimal to no compressible gasses may be present within the vial lumen 116 of the pre-filled cartridge 409 (FIG. 43).

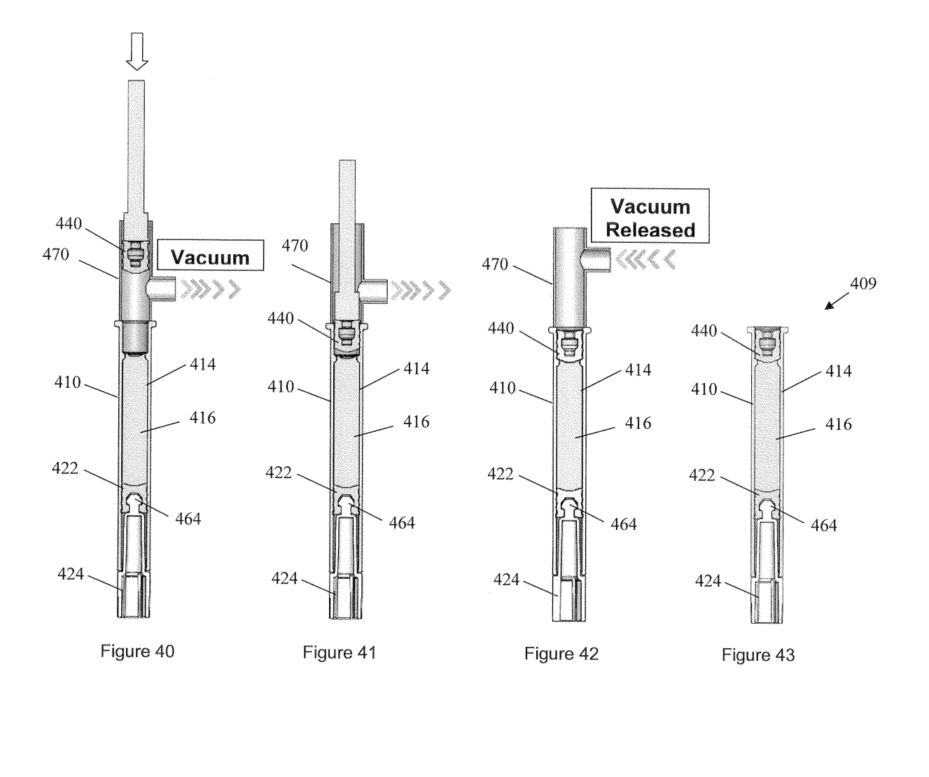

FIG. 40 illustrates a tool 470 that can seal against the proximal end of the vial 410 allowing the fill equipment to pull a partial vacuum on the vial 410. The post 464, which can be engaged with the floating stopper 422, can prevent the floating stopper 422 from moving proximally as a vacuum is applied as shown.

With reference to FIG. 41, a fixed stopper 440 can be inserted into the proximal end of the vial 410 such that a seal is created between the fixed stopper 440 and the vial 410.

When the vacuum is released, the fixed stopper 440 can seat itself within the vial 410 as shown in FIG. 42. It will be appreciated that any suitable method of vacuum assisted filling is contemplated. FIG. 43 depicts a vial 410 that can be ready for post fill production as described in accordance with versions herein.

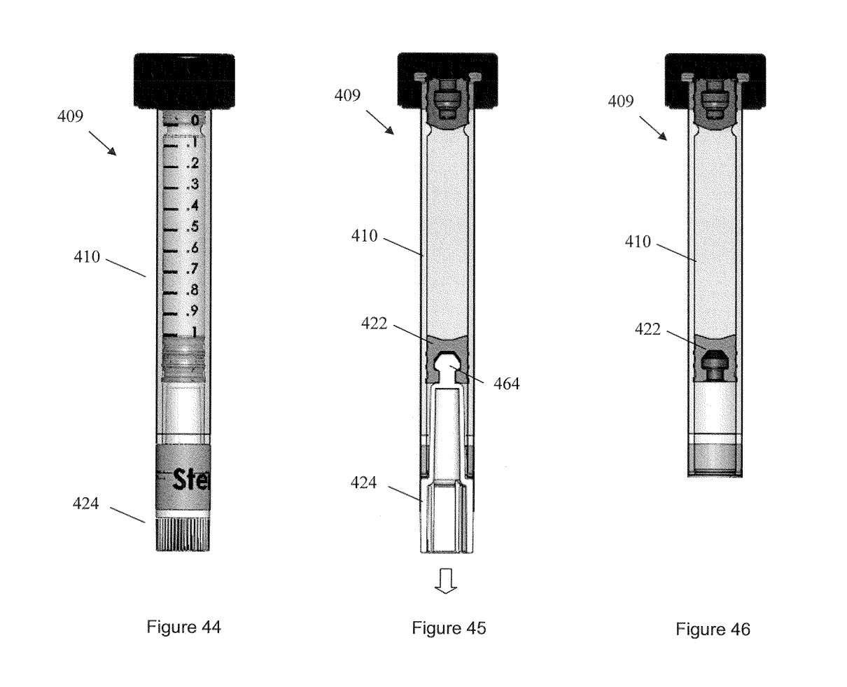

FIG. 44 depicts one version of a pre-filled cartridge 409 that can be received by an end user. The user can remove the distal cap 424, as shown in FIG. 45, prior to coupling the vial 410 to, for example, a shuttle, prefilled syringe device, syringe, or any other suitable fluid delivery system. In one version, the post 464 can be configured to selectively disengage from the floating stopper 422 with a force lower than the force needed to pull the floating stopper 422 out of the vial 410. FIG. 46 illustrates a version of the vial 410 after the distal cap 424 has been removed.

The foregoing description of embodiments and examples of the invention has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate the principles of the invention and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A cartridge comprising:
(a) a vial body defining a vial lumen, the vial body having a proximal end and a distal end;
(b) a flange positioned at about the proximal end of the vial body;
(c) a floating stopper positioned within the vial lumen defined by the vial body, the floating stopper having a proximal end and a distal end;
(d) an end cap, the end cap having a proximal end and a distal end, wherein the proximal end of the end cap abuts the distal end of the floating stopper such that the floating stopper is retained at a first position within the vial lumen.

2. The cartridge of claim 1, wherein the end cap is configured for removal from the vial body after at least a portion of the vial lumen is filled with a fluid.

3. The cartridge of claim 1, wherein the distal end of the end cap is configured to engage a filling tub.

4. The cartridge of claim 1, wherein the flange is configured to engage a tooling nest.

5. The cartridge of claim 1, wherein the proximal end of the vial body is configured to accept a fixed stopper.

6. The cartridge of claim 5, wherein a button is configured to engage the fixed stopper.

7. The cartridge of claim 1, wherein the floating stopper is formed from an elastomeric material.

8. The cartridge of claim 1, wherein the end cap is sized such that the vial lumen is filled with a predetermined amount of fluid.

9. The cartridge of claim 8, wherein the fluid is a medicament.

10. A method of filling a cartridge comprising the steps of:
providing a vial body defining a vial lumen, the vial body having a proximal end and a distal end;
providing a floating stopper positioned within the vial lumen defined by the vial body, the floating stopper having a proximal end and a distal end;
providing an end cap, the end cap having a proximal end and a distal end, wherein the proximal end of the end cap abuts the distal end of the floating stopper such that the floating stopper is prevented from moving distally within the vial lumen;
filling at least a portion of the vial lumen with a fluid; and
removing the end cap from the vial body after filling at least a portion of the vial lumen with the fluid.

11. The method of claim 10, further comprising the step of engaging the distal end of the end cap with a filling tub prior to filling at least a portion of the vial lumen with a fluid.

12. The method of claim 11, further comprising the step of sealing the filling tub within a pouch.

13. The method of claim 12, further comprising the step of sterilizing the filling tub.

14. The method of claim 10, wherein the proximal end of the vial body is configured to accept a fixed stopper.

15. The method of claim 14, wherein a button is configured to engage the fixed stopper.

16. The method of claim 10, wherein the floating stopper is formed from an elastomeric material.

17. The method of claim 10, wherein the end cap is sized such that the vial lumen is filled with a predetermined amount of fluid.

18. The method of claim 15, wherein the fluid is a medicament.

19. The method of claim 15, wherein providing a vial body, providing an end cap, and providing a floating stopper occur prior to filling at least a portion of the vial lumen with the fluid.

20. The method of claim 15, further comprising the step of creating a vacuum in the vial lumen.
